(19) United States
(12) Patent Application Publication
(10) Pub. No.: US 2017/0145284 A1
(43) Pub. Date: May 25, 2017

(54) HIGH-DENSITY COMPLETION BRINES

(71) Applicant: BAKER HUGHES INCORPORATED, Houston, TX (US)

(72) Inventors: Marcus Robert Davidson, Inverurie (GB); ROSA SWARTWOUT, Spring, TX (US); ANDREW DEFREES, Cypress, TX (US); MOCTESUMA R. TREVINO, Houston, TX (US); MAHIR DAIFALLA ALRASHDAN, Euless, TX (US); STEPHEN MILLER, Glasgow (GB); JENNIFER ROBERTSON, Houston, TX (US)

(73) Assignee: BAKER HUGHES INCORPORATED, Houston, TX (US)

(21) Appl. No.: 15/358,750

(22) Filed: Nov. 22, 2016

Related U.S. Application Data
(60) Provisional application No. 62/258,901, filed on Nov. 23, 2015.

(51) Int. Cl. C09K 8/05; C09K 8/42; C09K 8/52

(52) U.S. Cl. CPC C09K 8/05; C09K 8/52; C09K 8/426

(57) ABSTRACT

High density brine compositions may be formulated including water and at least one rare earth nitrate salt, where the at least one rare earth salt is present in an amount effective for the high density brine composition to have a density in the range of about 8.5 to about 21 pounds per gallon (about 1020 to about 2500 kg/m³). Suitable rare earth nitrate salts include, but are not necessarily limited to, lanthanum nitrate (La(NO₃)₃), cerium nitrate (Ce(NO₃)₃), scandium nitrate, and/or yttrium nitrate. Alkaline earth metal salts such as, but not limited to, calcium bromide (CaBr₂), and alkali metal salts and metal salts may also be used with the rare earth nitrate salt(s). In one non-limiting embodiment the high density brines have an absence of zinc and cesium salts. These high density brine compositions may be suitably used for completion fluids in hydrocarbon recovery operations.

### CROSS-REFERENCE TO RELATED APPLICATION

This application claims the benefit of U.S. Provisional Patent Application Ser. No. 62/258,901 filed Nov. 23, 2016, incorporated herein by reference in its entirety.

### TECHNICAL FIELD

The present invention relates to brine compositions having high density and applications for using them, and more particularly relates, in one non-limiting embodiment, to brine compositions having high density which are suitable for use in the drilling, stimulation and completion of subterranean oil and gas wells.

### BACKGROUND

In the exploration for, and production of, hydrocarbons, such as oil and gas, contained in subterranean formations, if the operator decides there is enough oil and/or gas present to justify the cost of producing the well, the well is completed prior to production. A completion fluid is a solids-free liquid used to “complete” an oil or gas well. The completion fluid is placed in the well to facilitate final operations prior to the start of production, such as setting screens and production liners, packers, downhole valves and/or shooting perforations into the producing zone(s). Completion fluids are meant to control the well should downhole hardware fail, without damaging the producing formation or the completion equipment and components. Completion fluids are typically brines (e.g. chlorides, bromides, formates, etc. and combinations thereof), but theoretically could be any fluid of the proper density and flow characteristics. The completion fluid should be chemically compatible with the reservoir formation and fluids, and is typically highly filtered to avoid introducing solids into the near-wellbore area. Thus, regular drilling fluids are rarely suitable for use in completion operations due to their solids content, pH and potential to cause formation damage.

Thus, clear brines are typically used in the completion of wells. However, to achieve a brine density above 14 pounds per gallon (ppg; 1700 kg/m³), typically either a zinc-based brine or a cesium formate-based brine is used. However, zinc is a known marine pollutant and cesium formate is prohibitively expensive.

It would be desirable if alternative high density compositions could be devised which meet the technical requirements of a completions fluid including, but not necessarily limited to, true crystallization temperature (TCT) and crystallization temperature at pressure, and which meet environmental regulations. It would also be desirable if these high density brine compositions could be used in applications other than completing a well.

### SUMMARY

There is provided, in one non-limiting form, a high density brine composition that includes water and at least one rare earth nitrate salt, where the at least one rare earth salt is present in an amount effective for the high density brine composition to have a density in the range of about 8.5 to about 21 pounds per gallon (about 1020 up to about 2500 kg/m³).

In a different, non-restrictive embodiment, there is provided a method of recovering a hydrocarbon from a subterranean formation which includes completing a well, where the method involves circulating a high density completion brine composition in a well, where the high density completion brine composition includes water and at least one rare earth nitrate salt, where the at least one rare earth salt is present in an amount effective for, or to cause or to increase, the high density brine composition to have a density in the range of about 8.5 to about 21 pounds per gallon (about 1020 up to about 2500 kg/m³).

### DETAILED DESCRIPTION

A new salt composition has been discovered which comprises at least one rare earth nitrate that can impart high densities individually or in combination with conventional brines. These new solids-free high density brine compositions are suitable for applications in drilling, completion and the stimulation of subterranean oil and gas wells. Fluids used in drilling, completion and stimulation of the subterranean oil and gas wells include, but are not necessarily limited to, completion fluids, perforating fluids, water-based drilling fluids, inverted emulsion drilling fluid, gravel pack, drill-in fluids, packer fluids, workover fluids, displacement, fracking fluids and remediation fluids. The rare earth metals include, but are not necessarily limited to, the lanthanides series of the periodic table as well as scandium and yttrium. The rare earth nitrate salts offer compatibility with aqueous formation fluid exceeding or on par with traditional halide completion brines.

As defined herein, a high density brine has a density in the range of about 8.5 independently to about 21 pounds per gallon (ppg) (about 1020 up to about 2500 kg/m³); alternatively about 14 independently to about 21 ppg (about 1700 up to about 2500 kg/m³); and in another non-restrictive version from about 15 independently to about 21 ppg (about 1800 up to about 2500 kg/m³). In additional non-limiting versions, high-density brines are defined as those having a density of about 15 ppg independently up to about 19 ppg (about 1800 independently up to about 2300 kg/m³), alternatively about 16 ppg independently up to about 18.5 ppg (about 1900 independently up to about 2200 kg/m³). Alternative lower limits for the definition of “high density” include, but are not necessarily limited to, about 9 ppg (about 1100 kg/m³), about 10 ppg (about 1200 kg/m³), about 11 ppg (about 1300 kg/m³), about 12 ppg (about 1400 kg/m³), about 13 ppg (about 1600 kg/m³), and about 15.4 ppg (about 1800 kg/m³). Use of the term “independently” herein with respect to a range means that any lower threshold may be combined with any upper threshold to give an acceptable alternative range. In non-limiting embodiments, these densities are achieved using only the rare earth nitrate salts, or using only the rare earth nitrate salts and additional metal salts as described herein.

In more detail, the rare earth nitrate salt may be any rare earth nitrate that accomplishes the purpose of forming a high density brine. Lanthanide nitrates are a generally acceptable class of salts; where the term “lanthanide” refers to the rare earth lanthanide series. Specific suitable examples include, but are not necessarily limited to, lanthanum nitrate (La(NO₃)₃), cerium nitrate (Ce(NO₃)₃), scandium nitrate, yttrium nitrate, and combinations thereof.

In one non-limiting embodiment, the amount of rare earth nitrate salt ranges from about 0.1 independently to about 75 wt % based on the total high density brine composition; in a different non-restrictive version from about 1 independently to about 65 wt %; in another non-limiting version from about 3 independently to about 30 wt %; alternatively from about 5 independently to about 25 wt %; in another non-limiting embodiment from about 10 independently to about 20 wt %.

Certain other salts may be present along with the rare earth nitrate salt, including, but not necessarily limited to, at least one alkali metal salt, at least one alkaline earth metal salt, and/or at least one metal salt including, but not necessarily limited to formate salts, chloride salts, bromide salts, acetate salts, nitrate salts, phosphate salts, citrate salts, tartrate salts, iodide salts, glutamate salts, diglutamate salts, nitriloacetate salts, lactate salts, malate salts, gluconate salts, polyacrylates, polymethacrylates, polysulfonates, and combinations thereof. In a non-limiting example, calcium bromide (CaBr₂) may be used. Other specific suitable salts include, but are not necessarily limited to, formate salts (e.g. HCOOK, HCOONa, HCOOCs), chloride salts (e.g. NaCl, KCl, CaCl₂, ZnCl₂), bromide salts (e.g. NaBr, KBr, CaBr₂, ZnBr₂), acetate salts (e.g. cesium acetate, zinc acetate, magnesium acetate) and combinations thereof, with chloride salts (e.g. NaCl, KCl, CaCl₂, MgCl₂) optionally also present. The individual or total amount of metal salt(s), alkaline earth metal salt(s), and/or alkali metal salt(s) may range from about 0.1 independently to about to about 75% based on the total high density brine composition; in another non-limiting embodiment from about 30 independently to about 55 wt %; alternatively from about 35 independently to about 50 wt % based on the total high density brine composition; and in another non-limiting embodiment from about 10 independently to about 50 wt %.

In a different non-restrictive version, the high density brine composition has an absence of, and does not include, either a zinc salt and/or a cesium salt.

It is expected that the high density brine compositions described herein may be used in a wide variety of applications. Suitable completion applications for the high density brine composition include, but are not necessarily limited to, completion fluids, packer fluids, swell (or swellable) packer fluids, perforating fluids, the internal brine phase of an oil-based gravel packing fluids, and water-based gravel packing fluids. Suitable drilling applications include, but are not necessarily limited to, water-based drilling fluids, the internal brine phase of oil-based fluids, water-based reservoir drilling fluid, the internal brine phase of oil-based reservoir drilling fluids, and the internal brine phase of solids-free oil-based fluids. In a normal drilling fluid the fluid is designed to be as low cost as possible. However, for the reservoir drilling fluid, the aim is to cause minimal damage to the formation to maximize production. One way to do this is to minimize solids by using a relatively heavy weight brine to increase the density.

Suitable wellbore remediation applications include, but are not necessarily limited to, micro-emulsion clean-up spacer brine phases, brine phases for water-based filter cake clean up, acidization pills, casing washing displacement spacers, and cementing displacement spacers. These high density brine compositions will also be suitable for well plugging and abandonment applications. Suitable miscellaneous pill applications include, but are not necessarily limited to, kill pills, friction reducer pills, stimulation fluid pills, lost circulation material (LCM) placement pills, fracturing fluids, high viscosity sweep fluids, and stuck pipe pills.

In a non-limiting example, when the high density brine composition is used as a completion fluid, the method involves circulating the high density completion brine composition within the well. The high density brine composition should be essentially solids-free to serve as a completions fluid. By “essentially solids-free” is meant that the amount and type of solids present, if any, are configured to not interfere with the application of the fluid in a completion operation.

The true crystallization temperature or TCT is the temperature at which the brine becomes saturated and salt crystals begin to form. The TCT is typically measured at atmospheric pressure and gives a measure of the lowest temperature that a given brine can be used. Using a brine below its TCT can lead to serious consequences as the salt falls out of solution and the fluid density is severely reduced. Generally for deep-water applications a TCT significantly less than 30° F. (around −1° C.) is required but TCT in a range of about 20 to about 60° F. (about −6.7 to about 16° C.) is useful for shallower water applications where the seabed temperature is not as low. The changing TCT requirement will dictate the composition of the brine.

A broad range for TCT may be from about 0° F. independently to about 70° F. (about −18 independently to about 21° C.), alternatively from about 20° F. independently to about 60° F. (about −6.7 independently to about 16° C.).

In one non-limiting embodiment, the completion fluids described herein are not emulsified, that is, they do not have an appreciable oil phase emulsified with the water phase.

The invention will now be further discussed with respect to actual implementation of the invention in Examples which are not intended to limit the invention, but simply to further illustrate it.

### Examples 1-8

Eight high density brine compositions were made with the following proportions of rare earth nitrate salt, CaBr₂ salt, and water. The true crystallization temperature (TCT) was measured for each, and the results are presented in Table I below.

TABLE I
TCT Results for High Density Brines with Rare Earth Nitrate Salts

| | Density, ppg | | | | |
|---|---|---|---|---|---|
| Ex. | (kg/m³) | La(NO₃)₃ | CaBr₂ | H₂O | TCT, ° F. (° C.) |
| 1 | 14.3 (1670) | 1.00 wt. % | 53.17 wt % | 45.83 wt. % | <0 (−18) |
| 2 | 14.8 (1773) | 2.0 wt. % | 54.76 wt. % | 43.24 wt. % | 28 (−2.2) |
| 3 | 15.5 (1860) | 9.99 wt. % | 49.95 wt. % | 40.06 wt. % | 28 (−2.2) |
| 4 | 16.0 (1917) | 19.98 wt. % | 41.97 wt. % | 38.05 wt. % | <−5 (−20.6) |
| Ex. | Density | Ce(NO₃)₃ | CaBr₂ | H₂O | TCT |
| 5 | 14.5 (1737) | 3.52 wt. % | 51.21 wt. % | 45.27 wt. % | 0 (−18) |
| 6 | 14.8 (1773) | 5.85 wt. % | 49.87 wt. % | 44.28 wt. % | 0 (−18) |
| 7 | 15.0 (1797) | 9.06 wt. % | 48.51 wt. % | 42.44 wt. % | 0 (−18) |
| 8 | 15.5 (1860) | 14.13 wt. % | 45.71 wt. % | 40.16 wt. % | 0 (−18) |
| 9 | 16.0 (1917) | 20.36 wt. % | 41.90 wt. % | 37.73 wt. % | 0 (−18) |

In one non-limiting embodiment, for mixed cerium nitrate/calcium bromide brines, a maximum density may be 16.8 ppg (about 2010 kg/m³); with a specific gravity of 2.0182 comprising 50.1 wt % CaBr₂, 8.7 wt % Ce(NO₃)₃ and 41.1 wt % water. This is contrasted with a minimum density brine of 14.2 ppg (about 1700 kg/m³) and a specific gravity of 1.703 comprising no Ce(NO₃)₃ and 53 wt % CaBr₂ and 47 wt % water. These preliminary data indicate that the high density brine compositions containing one or more rare earth nitrate salt would be suitable for completion fluids.

In the foregoing specification, the invention has been described with reference to specific embodiments thereof, and has been suggested as effective in providing effective high density brine compositions. However, it will be evident that various modifications and changes may be made thereto without departing from the broader scope of the invention as set forth in the appended claims. Accordingly, the specification is to be regarded in an illustrative rather than a restrictive sense. For example, specific combinations of rare earth nitrate salts, metal salts, alkaline earth metal salts, alkali metal salt, water, etc. and proportions thereof falling within the claimed parameters, but not specifically identified or tried in a particular composition to improve the properties of high density brine compositions, are anticipated to be within the scope of this invention.

The present invention may suitably comprise, consist or consist essentially of the elements disclosed and may be practiced in the absence of an element not disclosed. For instance, in one non-limiting embodiment there may be provided a high density brine composition consisting essentially of or consisting of water, and at least one rare earth nitrate salt; where the at least one rare earth salt is present in an amount effective for the high density brine composition to have, or to cause or to increase the density to a density in the range of about 8.5 to about 21 pounds per gallon (about 1020 up to about 2500 kg/m³).

There may also be provided a method comprising circulating a high density completion brine composition in a well, where the high density completion brine composition consists essentially of or consists of water, and at least one rare earth nitrate salt; where the at least one rare earth salt is present in an amount effective for the high density brine composition to have a density in the range of about 8.5 to about 21 pounds per gallon (about 1020 up to about 2500 kg/m³).

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A high density brine composition comprising:
water, and
at least one rare earth nitrate salt;
where the at least one rare earth salt is present in an amount effective to cause the high density brine composition to have a density in the range of about 8.5 to about 21 pounds per gallon (about 1020 to about 2500 kg/m³).

2. The high density brine composition of claim 1 where the rare earth nitrate salt is selected from the group consisting of lanthanum nitrate, cerium nitrate, scandium nitrate, yttrium nitrate, and combinations thereof.

3. The high density brine composition of claim 1 where the density is in the range of about 14 to about 21 pounds per gallon (about 1700 to about 2500 kg/m³).

4. The high density brine composition of claim 1 where the effective amount of rare earth nitrate salt ranges from about 0.1 to about 75 wt % based on the total high density brine composition.

5. The high density brine composition of claim 1 where the composition further comprises at least one metal salt, alkaline earth metal salt, or alkali metal salt selected from the group consisting of formate salts, chloride salts, bromide salts, acetate salts, nitrate salts, phosphate salts, citrate salts, tartrate salts, iodide salts, glutamate salts, diglutamate salts, nitriloacetate salts, lactate salts, malate salts, gluconate salts, polyacrylates, polymethacrylates, polysulfonates, and combinations thereof.

6. The high density brine composition of claim 5 where the effective amount of alkaline earth or alkali metal salt(s) ranges from about 0.10 to about 75 wt % based on the total high density brine composition.

7. A method comprising circulating a high density completion brine composition in a well, where the high density completion brine composition comprises:
water, and
at least one rare earth nitrate salt;
where the at least one rare earth salt is present in an amount effective to cause the high density completion brine composition to have a density in the range of about 8.5 to about 21 pounds per gallon (about 1020 to about 2500 kg/m³).

8. The method of claim 7 where in the high density completion brine composition, the rare earth nitrate salt is selected from the group consisting of lanthanum nitrate, cerium nitrate, scandium nitrate, yttrium nitrate, and combinations thereof.

9. The method of claim 7 where the density of the high density completion brine composition is in the range of about 14 to about 21 pounds per gallon (about 1700 to about 2500 kg/m³).

10. The method of claim 7 where in the high density completion brine composition the effective amount of rare earth nitrate salt ranges from about 0.1 to about 75 wt % based on the total high density completion brine composition.

11. The method of claim 7 where the high density completion brine composition further comprises at least one metal salt, alkaline earth metal salt, or alkali metal salt selected from the group consisting of formate salts, chloride salts, bromide salts, acetate salts, nitrate salts, phosphate salts, citrate salts, tartrate salts, iodide salts, glutamate salts, diglutamate salts, nitriloacetate salts, lactate salts, malate salts, gluconate salts, polyacrylates, polymethacrylates, polysulfonates, and combinations thereof.

12. The method of claim 11 where the amount of alkaline earth metal or alkali salt(s) ranges from about 0.1 to about 75 wt % based on the total high density completion brine composition.

13. The method of claim 7 where the high density completion brine composition is essentially solids-free.

14. A method for using a high density brine composition
where the high density brine composition is introduced into a wellbore during an application, where:
the high density brine composition comprises:
water, and
at least one rare earth nitrate salt;
where the at least one rare earth salt is present in an amount effective to cause the high density brine composition to have a density in the range of about 8.5 to about 21 pounds per gallon (about 1020 to about 2500 kg/m³); and
the application is selected from the group consisting of:
a completion application, and the high density brine composition is selected from the group consisting of:
completion fluids;
packer fluids;
swell packer fluids;
perforating fluids;
the internal brine phase of an oil-based gravel packing fluids; and
water-based gravel packing fluids;
a drilling application, and the high density brine composition is selected from the group consisting of:
water-based drilling fluids;
the internal brine phase of oil-based fluids;
water-based reservoir drilling fluid;
the internal brine phase of oil-based reservoir drilling fluids; and
the internal brine phase of solids-free oil-based fluids;
a wellbore remediation application, and the high density brine composition is selected from the group consisting of:
micro-emulsion clean-up spacer brine phases;
brine phases for water-based filter cake clean up;
acidization pills;
casing washing displacement spacers; and
cementing displacement spacers;
well plugging and abandonment applications; and
miscellaneous pill applications, and the high density brine composition is selected from the group consisting of:
kill pills;
friction reducer pills;
stimulation fluid pills;
lost circulation material (LCM) placement pills;
fracturing fluids;
high viscosity sweep fluids; and
stuck pipe pills.

15. The method of claim 14 where in the high density brine composition, the rare earth nitrate salt is selected from the group consisting of lanthanum nitrate, cerium nitrate, scandium nitrate, yttrium nitrate, and combinations thereof.

16. The method of claim 14 where in the high density brine composition the effective amount of rare earth nitrate salt ranges from about 0.1 to about 75 wt % based on the total high density brine composition.

17. The method of claim 14 where the high density brine composition further comprises at least one metal salt, alkaline earth metal salt, or alkali metal salt selected from the group consisting of formate salts, chloride salts, bromide salts, acetate salts, nitrate salts, phosphate salts, citrate salts, tartrate salts, iodide salts, glutamate salts, diglutamate salts, nitriloacetate salts, lactate salts, malate salts, gluconate salts, polyacrylates, polymethacrylates, polysulfonates, and combinations thereof.

18. The method of claim 17 where the amount of alkaline earth metal or alkali salt(s) ranges from about 0.1 to about 75 wt % based on the total high density brine composition.

19. The method of claim 14 where the high density brine composition is a completion brine and is essentially solids-free.

20. The method of claim 14 where the high density brine composition further comprises at least one metal salt, alkaline earth metal salt, or alkali metal salt selected from the group consisting of formate salts, chloride salts, bromide salts, acetate salts, nitrate salts, phosphate salts, citrate salts, tartrate salts, iodide salts, glutamate salts, diglutamate salts, nitriloacetate salts, and combinations thereof.
